(19) United States
(12) Patent Application Publication
(10) Pub. No.: US 2002/0158895 A1
(43) Pub. Date: Oct. 31, 2002

(54) Method of and a system for distributing interactive audiovisual works in a server and client system

(76) Inventors: Yotaro Murase, Aichi-Gun (JP); Hidematsu Kasano, Hiratsuka-shi (JP)

Correspondence Address: JACOBSON HOLMAN PLLC, 400 SEVENTH STREET N.W., SUITE 600, WASHINGTON, DC, 20004, US

(21) Appl. No.: 10/171,978

(22) Filed: Jun. 17, 2002

Related U.S. Application Data
(63) Continuation of application No. PCT/JP99/07116, filed on Dec. 17, 1999.

(51) Int. Cl. G09G 5/00

(52) U.S. Cl. 345/716

(57) ABSTRACT

A method of and a system for distributing interactive audiovisual works from a server computer to a client computer in response to a user input at the client computer without an interruption of displaying motion pictures is disclosed. According to the present invention, a system for distributing an interactive audiovisual work including a plurality of streams of motion pictures, which streams are selectively connected to display continued motion pictures, comprising: a server computer including storage means for storing an interactive audio visual work including the plurality of the streams; means for receiving a signal from a client computer; means for selecting one of the plurality of the streams to be connected with a stream being displayed at the client computer in accordance with predetermined criteria; buffer means for storing several streams to be selected by the means for selecting in a predetermined order; and means for sending a stream selected by means for selecting from the buffer means to the client computer, and the client computer including means for receiving a user input; means for sending the user input to the server computer; means for receiving streams from the server computer; and means for decompressing and displaying the received streams. The connection parts of the streams to be connected each other have the same or substantially the same image.

### TECHNICAL FIELD

The present invention generally relates to a method of and a system for distributing interactive audiovisual works in a server and client system, and particularly, to a method of and a system for distributing interactive audiovisual works from a server computer to a client computer seamlessly in response to a user or viewer input at the client computer without an interruption of the display of the motion pictures being viewed, glitches at the client computer, and the deterioration of the display and sound of the interactive audiovisual works being viewed at the client computer. The present invention also relates to a method of and an apparatus for creating an interactive audiovisual work.

An interactive audiovisual work means an audiovisual work which can respond in some way to a user input through an input device including a keyboard, a pointing device, such as, a mouse, a touch screen, or a microphone with or without a prompt to a user from the audiovisual work during the display of the audiovisual work.

### BACKGROUND ART

In order to reduce labor cost, improve working condition, or attract people's attention to new services and entertainment, an interactive technology and apparatus which respond to a user as if a human operator were responding to the user have been developed. For example, a known interactive method is designed to create an image of human operator by computer graphics and display the image on a monitor screen in order to respond to a user input. Another example is an interactive audiovisual apparatus which stores plural patterns of video data of actual scenery and which selects and displays the stored video data in response to a user input so that a user in front of a display screen feels as if the user were freely strolling in a real scenery. Such an apparatus gives a user virtual reality in real time.

It is remarkable that the performance of a personal computer has been rapidly improved and the cost of a personal computer has been decreased. Under these circumstances, there is a strong demand for contents of a high definition and natural quality images. Such contents are preferably interactive audiovisual works which can seamlessly respond to a user input so as to select and develop a number of scenarios in response to the user input since the user not only views the audiovisual work passively but also actively takes part in the audiovisual work. Since a user can alter such contents in accordance with his or her own preference or needs, such contents would be broadly accepted and attract users for a longer period.

However, the conventional virtual reality technology using computer graphics requires an enormous computation power of hardware in order to create an interactive audio visual work of a high definition with natural movement of images in real time in response to a user input. On the hand, there is a limitation of the expression and definition of images with respect to a low cost hardware affordable for many users.

If an interactive audiovisual work is so created that the interactive comprises motion pictures taken by a conventional video camera and responds to a user input by selecting one of the video images to display, the images of the audiovisual work can be made with high definition and the images can move naturally. However, it is difficult to connect the motion pictures taken by a conventional video camera seamlessly in response to a user input. In order to keep continuity of the motion pictures connected in response to a user input, the display time for each of the motion pictures need to be longer and it takes more time to connect the motion pictures in response to a use input. Therefore, response time for a user input will become longer. In order to keep a response time shorter, it is necessary to make display time of each of the motion pictures shorter so as to quickly switch and connect another motion pictures selected by a user input. However, this tends to cause an interruption and discontinuity problems of display of the motion pictures.

Particularly, when video images of an interactive audiovisual work display a person or other object which changes its complicated shape continuously, if each of the motion pictures is separately taken by a conventional video camera, connection parts of the motion pictures can not be registered very well due to the difficulties of taking motion pictures of such a moving object. As a result, the connection of the motion pictures in response to a user input causes an awkward and unnatural display of images, or an interruption of display of the motion pictures.

Therefore, prior art technique for making an interactive audiovisual work from motion pictures taken by a conventional video camera is not useful to make more realistic interactive audiovisual work which has continuing motion pictures and a quick response to a user input.

Prior art can not provide a method of creating interactive audiovisual works, an apparatus for and a method of displaying interactive audiovisual works which are able to develop a number of scenarios depending on a user's choice by selecting and combining seamlessly and naturally a number of motion pictures and sound data in response to a user input at reasonable cost.

The inventors of the present application filed a Japanese patent application No. 10-172701 (the counterpart of U.S. patent application Ser. No. 09/335,634) on Jun. 19, 1998 which discloses a method of creating interactive audiovisual works, an apparatus for and a method of displaying interactive audiovisual works which are able to develop a number of scenarios depending on a user's choice by selecting and combining seamlessly and naturally a number of motion pictures and sound data in response to a user input so as to give a user an impression as if the user communicated with a person or object in the interactive audiovisual works.

According to the Japanese patent application No. 10-172701, interactive audiovisual works which have natural images of high resolution, versatility to develop a number of scenarios, seamless connection of video and sound data and natural responsiveness to a user input are provided.

The Japanese patent application No. 10-172701 discloses a method of creating an interactive audiovisual work comprising a number of streams including video and sound data. A stream is a unit of an interactive audiovisual work and has video and sound data to be reproduced or displayed for a certain time. A stream may be made from real motion pictures taken by a video camera, synthesized motion pictures created by computer graphics or video data made by other motion picture creation technique. Sound data or other information may be included in the stream.

At least some of the streams can be selectively connected each other to display continued motion pictures on a display screen in response to a user input. A next stream can be selected by and sent from a server computer to a client terminal in response to a user input or automatically irrespective of any user input. The next stream is received by and displayed at the client terminal so as to connect seamlessly with a preceding stream. Thus, an audiovisual work of this Japanese patent application can display versatile and variable stories on a screen by selecting and connecting streams in response to a user input.

According to the application No. 10-172701, streams which are to be connected each other are created so as to have the same or substantially the same starting and ending images. Therefore, the streams can be connected seamlessly without any interruption or glitch of motion pictures being displayed at the connection so as to develop a story smoothly and naturally.

The display or reproducing time of a stream in which a user input is acceptable is usually chosen several seconds. If it takes several seconds for a stream which accepts a user input to display images or reproduce sounds included in the stream, a server could respond to a user input so as to select, retrieve, and send a next stream and a client terminal can decompress and display the received next stream within a natural response period of time in any case.

### PROBLEMS SOLVED BY THE INVENTION

The present invention improves the invention disclosed by the Japanese patent application No. 10-172701.

One object of the present invention is to provide a method of and an apparatus for distributing interactive audiovisual works in a server and client system through a network which can distribute interactive audiovisual works efficiently without any unnatural interruption and glitch of the display of motion pictures and the reproduction of sounds at the client terminal, improve the responsiveness to a user input and management of the system.

In prior art method and system for distributing interactive audiovisual works from a server computer to a client computer, a server application called as a universal demon is used to deal with a user input from a client computer in a server computer. There is, however, some risk that server programs and server data could be rewritten without any authorization or destroyed by a client since a client computer can control a server computer through a universal protocol using such a demon.

In addition, the prior art method using such a demon is not efficient to deal with the process for distributing interactive audiovisual works from a server computer to a client computer. For example, in case of occurrence of a communication failure, a user input can not reach at a server computer. Thus, a sever computer stops the distributing streams of interactive audiovisual works since the server computer can not tell which stream is selected by the user as a next stream. In order to prevent such a problem, communication error checking is necessary. But, since the communication error checking needs some time for processing, overall process time for selecting and sending a next stream in response to a user input gets longer. As a result, the prior art method and system have a problem that it can not efficiently distribute interactive audio visual works in response to a user input.

In addition, in the prior art method and system, a client computer has a control program in order to access to interactive audiovisual works stored in a server computer. The control program has some risk that the control program may be erased, reverse engineered, and rewritten without authorization. It is also difficult to maintain a control program stored in every client computer since updating a control program needs to be done with respect to every client computer.

Moreover, since a client computer has to decompress and display a stream received from a server, if a client computer is provided with a computer program to select a next stream stored in a server computer, it would increase the computational load of a client computer and the overall time required for sending and receiving a stream would increase. It would be impossible to use a stream having shorter display or reproduction time in order to respond to a user input more quickly. Furthermore, when a communication error between a server and client computers occurs, the server computer can not send a next stream because of no user input and the client computer stops displaying motion pictures soon.

An apparatus for sending interactive audiovisual works disclosed in the Japanese patent application No. 10-172701 starts a retrieval process for a next stream after a predetermined input period of time for a stream being displayed has lapsed. After a predetermined input period of time for a stream being displayed, retrieval process for a next stream begins. Then, a next stream is selected, retrieved, fetched, and stored in a sending buffer to send to a client computer in order to display the next stream on the client computer. From the retrieval process to the displaying of a next stream, a user input is halted or prohibited.

In order to improve the responsiveness to a user input, it is necessary to shorten this period while a user input is halted or prohibited as short as possible. In order to shorten this period while a user input is halted or prohibited, a retrieval process for a next stream should begin as late as possible in display time of a stream. However, in order to send a next stream without any interruption or glitch of motion pictures being displayed, a next stream must be selected, retrieved, fetched, and sent to a client computer within a predetermined time limit. Therefore, it is a limit to defer a retrieval process in order to avoid the interruption halt of the display of motion pictures at a client computer. There is a limitation to improve the responsiveness to a user input.

Furthermore, if the retrieval processes for a next stream for a plurality of client computers occur in a certain period of time, the conflict of access by the plurality of clients to hard disk drives which store next streams happen. This results in the delay of the retrieval and fetching of next streams for a plurality of client computers. Next streams could not be distributed to each of the client computers in time.

The present invention solves the above-mentioned problems.

Therefore, it is one object of the present invention to provide a method of and an apparatus for efficiently distributing interactive audiovisual works in a server and client system with improved responsiveness to a user input and improved control of the system.

It is another object of the present invention to provide a method of and an apparatus for distributing interactive audiovisual works in a server and client system which can connect streams including motion pictures and sound data seamlessly and selectively to display naturally continued motion pictures of interactive audiovisual works so that a viewer or listener can hardly notice the connection of the motion pictures.

It is other object of the present invention to provide a method of and an apparatus for distributing streams of an interactive audiovisual work including motion pictures in a server and client system in response to a user input without an interruption or halt of display of motion pictures.

### DISCLOSURE OF INVENTION

In order to fulfil the objects, the present invention provides an apparatus for distributing an interactive audiovisual work including a plurality of streams of motion pictures, which streams are selectively connected to display, in a server and client system, comprising: a server computer including storage means for storing an interactive audio visual work including the plurality of the streams; means for receiving a signal from a client computer; means for selecting one of the plurality of the streams to be connected with a stream being displayed at the client computer in accordance with predetermined criteria; a plurality buffer means for storing several streams to be selected by the means for selecting in a predetermined order; and means for sending a stream selected by the means for selecting from the buffer means to the client computer, and the client computer including means for receiving a user input; means for sending the user input to the server computer; means for receiving streams from the server computer; and means for decompressing and displaying the received streams.

The present invention also provides a method of distributing an interactive audiovisual work in a server and client system, comprising the steps of providing storage means in a sever computer, storing in the storage means an interactive audio visual work including a plurality of streams of motion pictures, which streams are selectively connected to display continued motion pictures, storing in the storage means stream codes including information about next streams to be selectively connected, providing a random access memory in the server computer, creating a table in the random access memory including a plurality of fields in which the stream codes are stored in a predetermined order, providing a plurality of buffer means in the server computer, storing in the buffer means the streams corresponding to the stream codes stored in the fields of the table, and sending from the buffer means to a client computer one of the streams which is selected by the server computer in accordance with predetermined criteria.

In accordance with the present invention, a server computer is provided with means for selection, that is, a control program, to select one of streams of an interactive audiovisual work stored in server computer in accordance with predetermined criteria in order to send to a client computer. Therefore, a client computer does not need to have means for selection (a control program). The client computer only has to receive a user input from a user, send the user input to a server computer, receive streams sent from the server computer, and then decompress and display the stream.

Since only a sever computer controls means for selection (a control program), the security of the server system can be improved. Moreover, the server computer can send suitable streams or interactive audiovisual works to each of users through the means for selection (a control program) by using statistics resulting from the usage of the system by each of users.

When a user input is not received by a server computer due to a communication error or etc., means for selection will send a default stream which is selected in accordance with predetermined criteria, for example, if there is no user input until sending a preceding stream is completed at a server computer, a default stream for no user input is selected as a next stream by a server computer. Therefore, it can prevent from an interruption or halt of displaying motion pictures or reproducing sounds at a client computer even if there is a communication error.

A plurality of buffer means in a server computer stores several next streams to be selected by means for selection in advance. Therefore, it is possible to send a next stream selected by a user input or other predetermined criteria from the buffer means to a client computer immediately after a server computer completes the sending of a preceding stream. Accordingly, the period of time while a user input is halted or prohibited for a user input acceptable stream can be decreased as short as the sum of time required for sending a part of a next stream to start displaying the next stream to a client computer and time required for decompressing that part at a client computer. As a result, the system almost always accepts a user input. If display time of each of streams is appropriately chosen, the system can substantially immediately respond to a user input so as to send a next stream requested by the user input to a client computer.

According to another aspect of the present invention, there is provided an apparatus for creating an interactive audiovisual work including a plurality of streams of motion pictures, which streams are connected to display continued motion pictures.

The present invention provides an apparatus for creating an interactive audiovisual work including a plurality of streams of motion picture, which streams are connected to display continued motion pictures, comprising: means for taking motion pictures of an object and generating video data of the motion pictures, means for creating still image data from the video data of the motion pictures and storing the still image data, means for synthesizing the video data and the still image data to create a synthesized image which superimposes the motion pictures on the still image, means for selectively display one of the motion pictures, the still image data, and the synthesized image on a monitor display.

According to another aspect of the present invention, there is provided a method of creating a preceding stream and a succeeding stream of motion pictures which are connected each other in order to display continued motion pictures.

The present invention provides a method of creating a preceding stream and a succeeding stream of motion pictures, the ending part of the preceding stream is connected the starting part of succeeding stream in order to display continued motion pictures, comprising the steps of: taking motion pictures of the preceding stream by a video camera and recording the motion pictures of the preceding stream, displaying the ending part of the preceding stream to be connected the succeeding stream as a still image on a monitor display, taking motion pictures of the succeeding stream to be connected the preceding stream by the video camera, displaying the starting part of the succeeding stream on the monitor display, repeating the step of displaying the starting part and the step of displaying the still image alternately in order to substantially register the starting part with the still image, and starting taking motion pictures from the starting part which substantially registers with the still image.

It is easy to create an interactive audiovisual work including a plurality of streams of motion pictures which can be connected each other to make continued motion pictures by using the above-mentioned apparatus and method of the present invention.

### BRIEF DESCRIPTION OF DRAWINGS

The present invention will become more fully understood from the detailed description given hereinafter and the accompanying drawings which are given by way of illustration only, and thus are not limitation of the present invention wherein:

FIG. 1 is a schematic block diagram of an apparatus for distributing interactive audiovisual works from a server computer to a client terminal in a server and client system in accordance with a preferred embodiment of the present invention.

FIG. 2 is a schematic block diagram of a control unit of transmitter and receiver of a server computer in a preferred embodiment of the present invention.

FIG. 3 is a schematic block diagram of a buffer provided in the transmitter of the server computer shown in FIG. 2.

FIG. 4 is a schematic diagram of streams of an interactive audiovisual work and their flows of a first preferred embodiment of the present invention.

FIG. 5 is a schematic diagram of streams of an interactive audiovisual work and their flows of a second preferred embodiment of the present invention.

FIG. 6 is a schematic diagram of streams of an interactive audiovisual work and their flows of a third preferred embodiment of the present invention.

FIG. 7 is a schematic diagram of a part of a stream code in accordance with a preferred embodiment of the present invention.

FIG. 8 is a schematic diagram of stream codes corresponding to the streams shown in FIG. 6.

FIG. 9 is a schematic diagram of several tables showing the relationship between stream codes, a user code table and a conversion table in accordance with a preferred embodiment of the present invention.

FIG. 10 is a schematic diagram of a table stored in a random access memory provided in a server computer of the present invention.

FIG. 11 is a flow diagram of basic operations of a server computer in accordance with a preferred embodiment of the present invention.

FIG. 12 is a flow diagram of basic operations of a client terminal in accordance with a preferred embodiment of the present invention.

FIG. 13 is a flow diagram of operations to deal with streams in accordance with a first preferred embodiment of the present invention.

FIG. 14 is a flow diagram of operations to deal with streams in accordance with a second preferred embodiment of the present invention.

FIG. 15 is a schematic diagram of a transmitter buffer provided in a server computer in accordance with a preferred embodiment of the present invention for use in the operations as shown in FIG. 14.

FIG. 16 is a schematic diagram of a table stored in a random access memory in a sever computer in accordance with a preferred embodiment of the present invention for use in the operations as shown in FIG. 14.

FIG. 17 is a schematic diagram of a part of a stream code in accordance with a preferred embodiment of the present invention for use in the operations as shown in FIG. 14.

FIG. 18 is a flow diagram of operations to deal with streams in accordance with a third preferred embodiment of the present invention.

FIG. 19 is a schematic diagram of a table in accordance with a preferred embodiment of the present invention for use in the operations as shown in FIG. 18.

FIG. 20 is a schematic diagram of a transmitter buffer means provided in a server computer in accordance with a preferred embodiment of the present invention for use in the operations as shown in FIG. 18.

FIG. 21 is a timing chart showing the relationship between time required to send a stream from a server computer, display time of the stream at the client terminal, and an input by a user at the client terminal.

FIG. 22 is a schematic diagram of an apparatus for creating an interactive audiovisual work including a plurality of streams of motion pictures in accordance with a preferred embodiment of the present invention.

FIG. 23 is a schematic diagram of a monitor display displaying a synthesized image.

### BEST MODE FOR CARRYING OUT THE INVENTION

### Server Computer and Client Computer

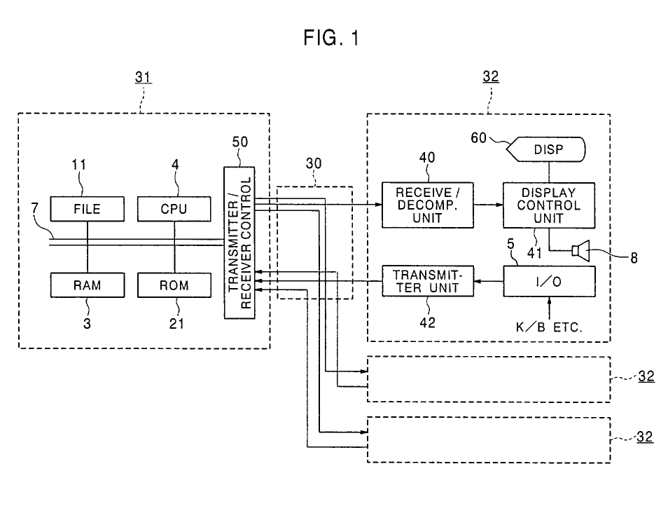

FIG. 1 is a schematic block diagram of a server computer and client computers for a system distributing interactive audiovisual works in a server and client system in accordance with a preferred embodiment of the present invention.

A server computer 31 comprises a file device 11, such as, a large volume of hard disk drive, for storing interactive audiovisual works including a plurality of streams of the invention, stream codes corresponding to the streams, control programs to control the server computer and related data, a read only memory (ROM) 21 for storing other control programs and data, a random access memory (RAM) 3 of volatile semiconductor memory device, a central processing unit (CPU) 4 for controlling processes for receiving and dealing with a user input, processes for retrieving, fetching, storing and sending streams, and other processes for the server 31, a transmitter and receiver control unit 50, and a bus 7 for connecting elements in the server computer 31.

A plurality of client computers are connected with the server computer 31 through a communication network 30, such as, LAN (local area network), WAN (wide area network) or public telephone line using dial-up connection services. The client computers 32 are sometimes referred to as client terminals which displays interactive audiovisual works to a user.

The client computer 32 comprises a display device (DISP) 6, such as, liquid crystal display or CRT, for displaying an interactive audiovisual work to a user, a speaker 8 for outputting reproduced sounds to a user, a receiver/decompression unit 40 for receiving streams from the server 31 and decompressing the received streams, a display control unit 41 for receiving decompressed streams from the unit 40 and for controlling displaying images on the display device 6 and reproducing sounds at the speaker 8, an I/O unit 5, such as, a keyboard (K/B), pointing device (mouse), touch screen, or microphone, for inputting a user input to the client computer 32, and a transmitter unit 42 for sending a user input to the server 31 through the network 30.

The server 31 sends the interactive audiovisual works stored in the file 11 to each of the client terminals 32 through the network 30 in accordance with predetermined criteria, such as, presence or absence of a user input from the clients 32, in order to display the interactive audiovisual works on the display device 6 at each of the client computers 32.

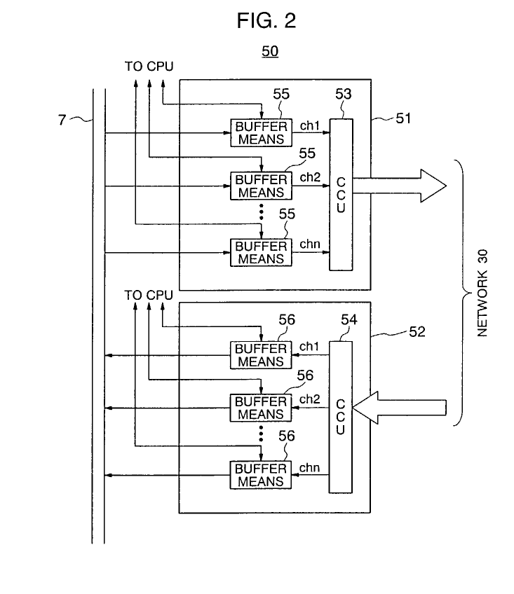

FIG. 2 is a schematic block diagram of the transmitter and receiver control unit 50 in the server 31. The unit 50 includes a transmitter part 51, a receiver part 52, and a plurality of channels ch1, ch2, . . . , chn for connecting each of corresponding clients 32 through the network 30.

The transmitter part 51 includes a plurality of transmitter buffer means 55 for storing data to be sent to each of the channels and a communication control unit (CCU) 53 for controlling the transmission of the data from each of the buffers to the network 30 under the control of the CPU 4. The receiver part 52 includes a plurality of receiver buffers 56 corresponding to each channel for storing received data from each of the client computers 32 and a communication control unit (CCU) 54 for controlling the distribution of the received data from the network 30 to each of the channels connecting each of buffers56.

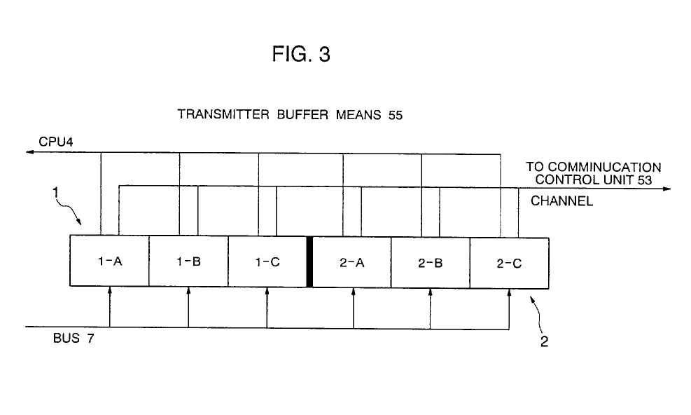

FIG. 3 is a schematic diagram of the transmitter buffer means 55. The transmitter buffer means 55 is divided into two parts, a first transmitter buffer 1 and a second transmitter buffer 2. There are three sub-sections 1-A, 1-B and 1-C, each of which stores a stream, in the first transmitter buffer 1. There are also three sub-sections 2-A, 2-B and 2-C, each of which stores a stream, in the second transmitter buffer 2. As explained later in more detail, each of streams which may be sent to one of the clients 32 from the server 31 during an odd number cycle is stored from the file 11 through the bus 7 into one of the three sub-sections 1-A, 1-B and 1-C, under the control of the CPU 4. Each of streams which may be sent to one of the clients 32 from the server 31 during an even number cycle is stored from the file 11 through the bus 7 into one of the three sub-sections 2-A, 2-B and 2-C, under the control of the CPU 4. A stream stored in one of the sub-sections 1-A, 1-B, and 1-C or 2-A, 2-B and 2-C, is selected by the CPU 4 in accordance with predetermined criteria, such as, presence or absence of a user input, or user information, in order to send to a client 32 through the channel. Then, the selected stream is sent to the client 32 through the communication control unit 53 and the network 30 in order to be displayed on the display device 6 at the client 32.

### Interactive Audiovisual Work

An interactive audiovisual work used in the present invention may be created by an apparatus or a method disclosed in the Japanese patent application No. 10-172701 or explained in detail later. An interactive audiovisual work used in the present invention comprises a plurality of streams. A stream contain motion pictures to be displayed for a certain time on a display. A stream may contain associated sound data in addition to the motion pictures or other data. The streams can be selected by predetermined criteria, such as, presence or absence of a user input, in order to sent to a client computer 32 and then connect with a preceding stream so as to display a continued motion pictures at the client 32.

Thus, the motion pictures of an interactive audiovisual work being displayed look like a “live” image which naturally responds to a user input rather than a “lifeless” image recorded in a storage as explained below.

Firstly, an interactive audiovisual work is more versatile since motion pictures of the interactive audiovisual work can develop various scenarios depending on user inputs. Secondly, the motion pictures of the interactive audiovisual work can develop various scenarios seamlessly and smoothly without any interruption or glitch of the motion pictures. Thirdly, the motion pictures of the interactive audiovisual work can respond to a user input with a natural response time without any unnatural delay.

Video data of motion pictures of a stream may be a person, an animal or a scenery taken by a video camera. Or, Video data of motion pictures of a stream may be image created by computer graphics or digital image processing technique. Video data of motion pictures of a stream is compressed by video data compression technique, such as, Sorenson Video. Sound data associated with video data of a stream is compressed by sound data compression technique, such as, Qualcomm Pure Voice. Both compressed image data and sound data of a stream are multiplexed by a suitable format, such as, Quick Time, to produce a stream of a certain amount of data. Then, the stream is stored into the file 11.

Streams are created by using an apparatus or a method explained in detail later so that connection parts of the streams to be connected each other, that is, the ending part of a preceding stream and the starting part of a succeeding stream connecting the preceding stream, have the same or substantially the same image. Since streams to be connected each other have the same image or substantially the same image at the connection parts, the streams can be connected seamlessly and smoothly.

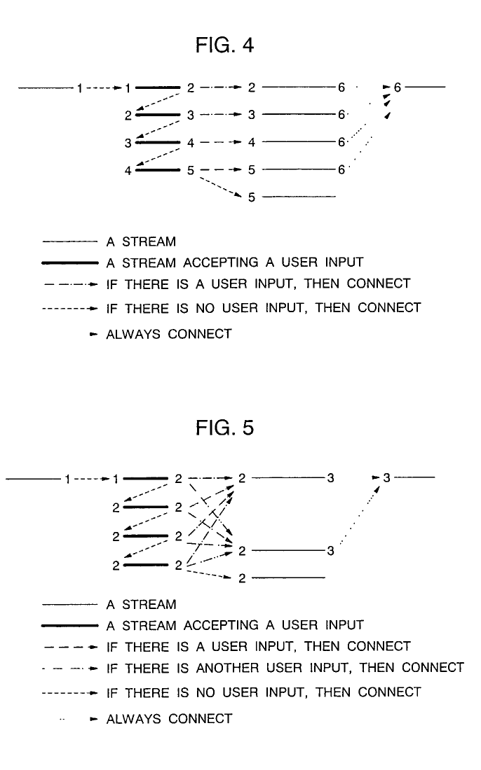

FIG. 4 is a schematic diagram of streams and their flows in which the streams are selectively connected in accordance with predetermined criteria, such as, presence or absence of a user input or other condition. In FIG. 4, a solid line segment means a stream. A solid line segment which is relatively thin means a stream which does not accept a user input. A solid line segment which is relatively thick means a stream which accepts a user input. The figure shown at the end of a stream means an image of connection part of the stream. The same figure means that the connection part, that is, the ending or starting part, of the stream has the same or substantially the same image. A dotted line segment with an arrow means a connection with a next stream from a preceding stream irrespective of any user input during the display of the preceding stream. A broken line segment with an arrow means a connection with a next stream from a preceding stream when there is no user input during the display of the preceding stream. A one-dotted chain line segment with an arrow means a connection with a next stream from a preceding stream when there is a user input during the display of the preceding stream. FIG. 4 shows a plurality of possible different flows, that is, scenarios to be developed by connecting different streams depending on user inputs made while a stream accepting a user input is displayed.

In order to avoid an endless loop which may happen when there are many streams accepting a user input in order to connect with many succeeding streams, it may be preferable to provide one stream to which any preceding streams are mandatory connected in the middle of or at the end of flows or the scenarios of an interactive audiovisual work. Such a stream is useful to control many flows or scenarios of an interactive audiovisual work.

FIG. 5 is another schematic diagram of streams and their flows in which the streams are selectively connected in accordance with predetermined criteria, such as, presence or absence of a user input or other condition. In FIG. 5, a stream can accept two kinds of user inputs instead of one kind of a user input acceptable in FIG. 4. There is a two-dotted chain line segment with arrow to connect with another next stream in addition to the one-dotted line segment with arrow in order to accept two kinds of user inputs. There are a plurality of different flows or scenarios of an interactive audiovisual work depending on the kinds of user inputs in FIG. 5.

An actual interactive audiovisual work may be made by using both of the streams and flows shown in FIG. 4 and FIG. 5.

Streams include any contents, such as, motion pictures, which may be different from other streams. But, the connection part of streams connecting to other streams need to have the same or substantially the same image as the connection part of the other streams. As explained above, an interactive audiovisual work which looks like “live” image, which responds to a user input, and which has versatility to develop various scenarios of the interactive audiovisual work can be made from the streams shown in FIG. 4 and/or FIG. 5.

Thus, a stream which can accept a user input can accepts a user input at any time while the stream is being displayed and immediately responds to the user input in order to connect with a next stream selected by the user input and display the selected stream. As a result, an interactive audiovisual work can respond to a user input with a natural responsiveness and “live” image. A preferred embodiment of the present invention is explained in more detail hereinafter.

According to a preferred embodiment of the present invention, a plurality of candidates of next streams to be selected are stored in the transmitter buffer means in a sever computer in advance so that a user input can be accepted at any time and the server computer can respond to a user input immediately in order to select and send a next stream.

In addition, a stream which accepts a user input for selecting a next stream to be connected has a display time of motion pictures less than several seconds, preferably, from 0.5 seconds to 5 seconds, in order to connect with a next stream with natural responsiveness to a user input.

By using the above-mentioned buffer means in the server computer for storing a plurality of candidates of next streams to be selected in advance and the above-mentioned streams which accept a user input and which have display times of motion pictures less than several seconds, an interactive audiovisual work in the server and client system can respond to a user input with natural responsiveness even under the limitations of hardware and software of the system and the communication network circumstances.

Although the streams which can accept a user input have relatively short display time of motion pictures, resulted motion pictures by connecting streams are seamless and smooth since the connection parts of the streams have the same or substantially the same images. A stream which do not accept a user input may have any length of display time of motion pictures depending on a scenario of an interactive audiovisual work.

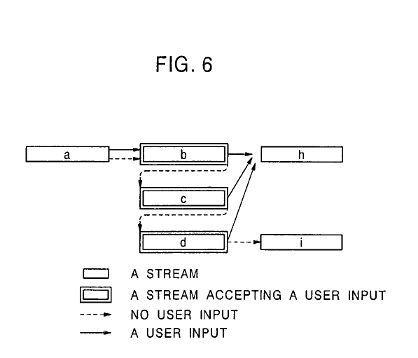

FIG. 6 is another schematic diagram of streams of an interactive audiovisual work and the flows or scenarios made of these streams. Rectangular boxes mean streams a, b, c, d, h, and i, respectively. Rectangular boxes enclosed with double lines mean streams b, c, d which accept a user input. In the flows shown in FIG. 6, the stream a always connects with the stream h irrespective of presence or absence of a user input. Then, the stream b connects with the stream h if there is a user input during the display of the stream b. The stream b connects with the stream c if there is no user input during the display of the stream b. Then, the stream c connect, with the stream h if there is a user input during the display of the stream c. The stream c connects with the stream d if there is no user input during the display of the stream c. Then, the stream d connects with the stream h if there is a user input during the display of the stream d. The stream d connects with the stream i if there is no user input during the display of the stream d. A line segment with arrow means a flow of streams when there is a user input during the display of a preceding stream. A dotted line segment with arrow means a flow of streams when there is no user input during the display of a preceding stream.

### Stream Code

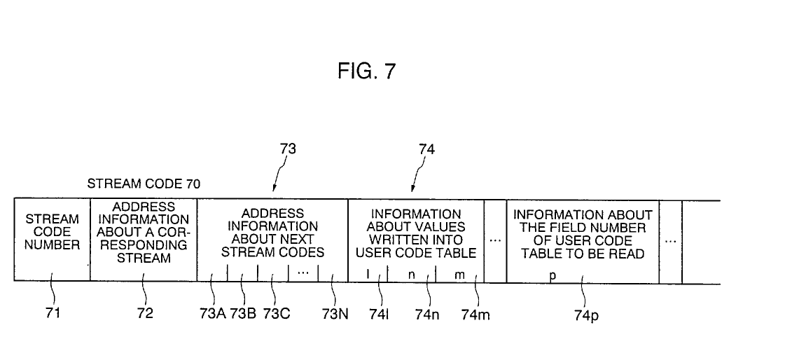

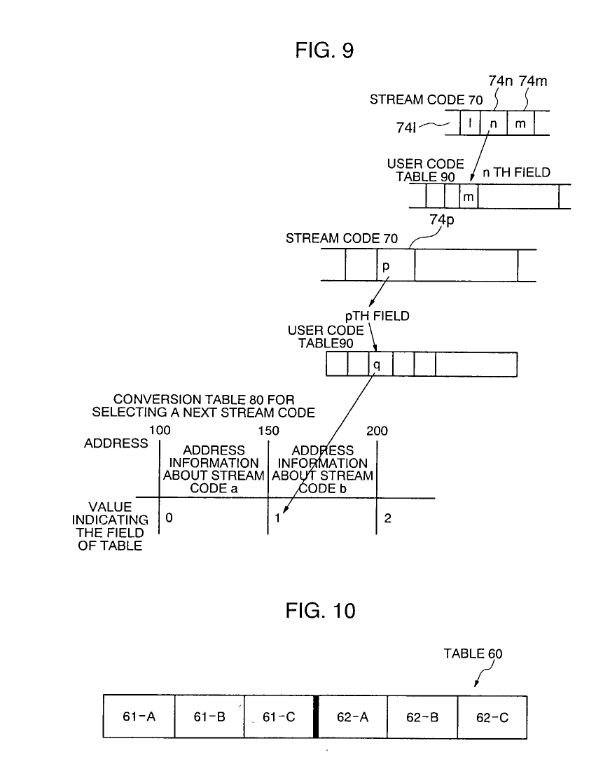

FIG. 7 is a schematic diagram showing a part of stream code 70 created for a corresponding stream. The stream code 70 is used by a server computer for the selection of streams. The stream code 70 has a stream number field 71 and a position field 72 indicating address information in the file 11 for a corresponding stream. In addition, the stream code 70 has next stream code position fields 73A, 73B, 73C, . . . , 73N for indicating address information about next stream codes corresponding to next streams to be connected with the corresponding stream in the field 72 in accordance with predetermined criteria, such as, presence or absence of a user input or other conditions. The stream code 70 has a field 74 for use in the writing and reading of a user code table 90 (FIG. 9). This field 74 includes a sub-field 741 for indicating how to write the user code table 90, a sub-field 74m for indicating which field of the user code table 90 is written, a sub-field 74n for indicating what value is written in the user code table 90, and a sub-field 74p for indicating from which field in the user code table 90 is read out.

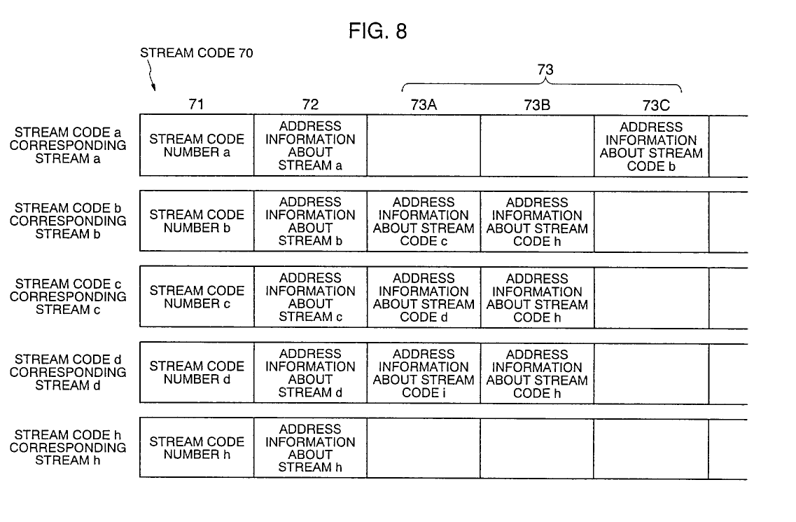

FIG. 8 is a schematic diagram showing a part of stream codes 70, each corresponding to each of the stream a. b. c. d. h of FIG. 6. Each of the stream codes 70 has a field 71 for storing stream code number, a field 72 for storing address information where a corresponding stream is stored in the file 11, fields 73A, 73B, 73C for storing address information where next stream codes are stored. Each of next stream codes corresponds a next stream to be connected with the corresponding stream in the field 72 in accordance with predetermined criteria, such as, presence or absence of a user input or other conditions.

FIG. 9 is a schematic diagram of a part of a user code table 90 to be used with the field 74 of the stream code 70 in order particularly to show a relationship between the stream code 70, the user code table 90, and a conversion table 80 for selection of a next stream. In the user code table 90, information, such as, an overall connection time for a particular user (client), the history of usage of the system by the user, and streams or interactive audiovisual works to be displayed to the user in response to a user input or based on other conditions, are written.

When the stream code 70 writes any information into a particular field in the user code table 70, the sub-field 74l of the stream code 70 is written by a value, for example, 1. When the value in the sub-field 74l is 1, the n-th field of the user code table 90 which is designated by a value n stored in the sub-field 74n of the stream code 70 for designating a field in the user code table 90 is updated with a value m stored in the sub-field 74m of the stream code 70 for designating a writing value in the user code table 90. Resetting of any field of the user code table 90 can be indicated with the value in the sub-field 74l in the stream code 70.

When the stream code 70 reads any information from a particular field in the user code table 90, the p-th field of the user code table 90 which is designated by a value p in the sub-field 74p of the stream code 70 for reading information from the user code table 90 is read by the server 31. Since the p-th field of the user code table 90 stores a value q, this value q is read by the server 31.

This value q read out by the server 31 from the user code table 90 is used to select a next stream with the conversion table 80. For example, if the value q, is 1, the value 1 is used to select a next stream from the conversion table 80. Thus, the field number 1 of the conversion table 80 designated by the value 1 is read and address for stream code b stored in the field number 1 is read. As a result, stream b corresponding to the stream code b is selected as a next stream code.

Before reading out a next stream code from the conversion table 80 with the value q from the user code table 90, the value q from the user code table 90 may be translated into another value by using a function table. Then, the translated value may be used in order to read out a next stream code from the conversion table 80 instead of using the original value q.

The stream code 70 may be separately stored in the file 11 from the streams. Alternatively, the stream code 70 may be attached to the header of a corresponding stream and thus stored with the corresponding stream in the file 11. In the latter case, the server computer will separate a stream code information from a stream to prepare for operations explained later.

When the server computer 31 becomes ready for connecting with a client computer 32, all stream codes stored in the file 11 are transferred to a random access memory 3 in the server computer 31 in order to prepare for quick selection and distribution of streams since it takes more time to directly read out stream codes from the file 11. A stream code has a data size of approximately 100 bytes. Total data size for all stream codes corresponding to all streams for considerable length of the display time (100 hours) is approximately 10 megabytes or so. It is possible to store all stream codes into the random access memory 3 in the server computer 31 when the server is ready for connecting with a client computer 32. Alternatively, when every user ends the use of an interactive audiovisual work, information indicating the addresses in the file 11 for streams and stream codes to be used next time when the particular user connects with the server computer 31 again to use the interactive audiovisual work may be stored in the user code table. If the particular user connects with the server computer 31 to use the interactive audiovisual work next time, stream codes which are only indicated by the user code table to be used next time may be transferred to the random access memory 3 from the file 11.

An interactive audiovisual work including a plurality of streams to be connected each other is sent to each of client computers 32 through a corresponding channel ch by a so-called table-driven method. FIG. 10 is a schematic diagram of a table 60 having a plurality of data fields made by the server computer 31 in the random access memory 3 when a client connects with the server computer 31. Each of the stream codes 70 which has been transferred to the random access memory 3 is stored in each of the fields of this table 60 in a way as explained in detail later.

This table 60 has the fields 61-A, 61-B, 61-C and 62-A, 62-B, 62-C for storing stream codes 70, each corresponding to each of the sub-sections 1-A, 1-B, 1-C and 2-A, 2-B, 2-C of the transmitter buffer means 55 in FIG. 3. The user code table 90 and the conversion table 80 may be transferred from the file 11 to the random access memory 3 all together for quick operations as well as the stream codes 70 when a client computer 32 connects with the server computer 31.

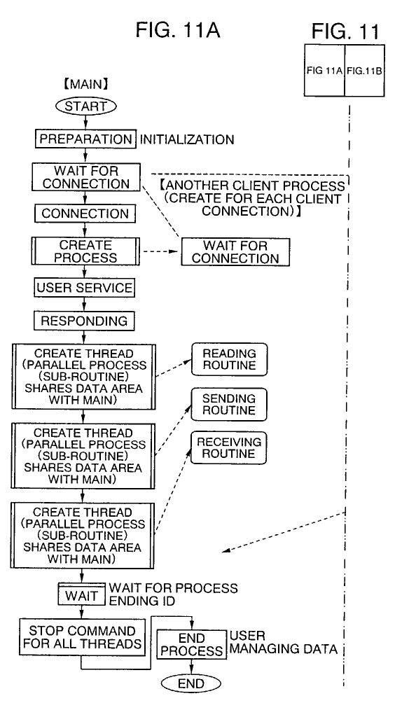

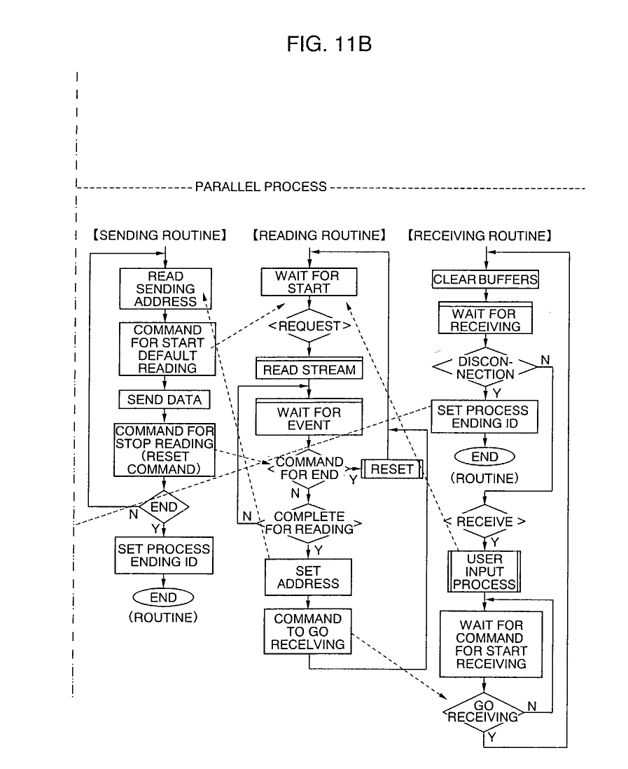

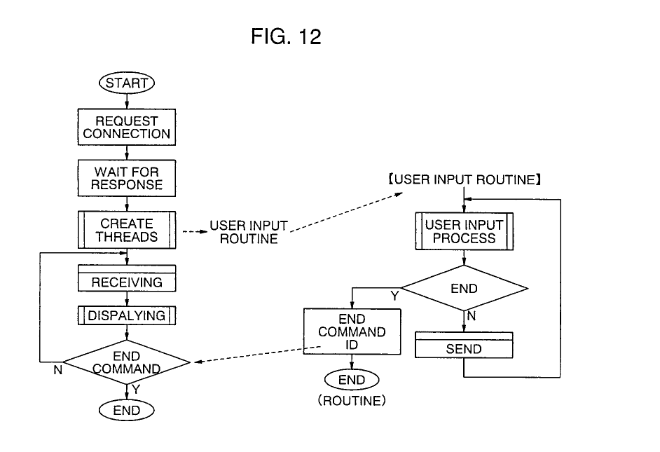

An interactive audiovisual work is distributed from the server computer 31 to client computers in order to display the interactive audiovisual work on each of the client computers 32 in response to a user input or the connection made between the server computer and client computers. FIG. 11 is a flow diagram showing overall operations in the server computer 31. FIG. 12 is a flow diagram showing overall operations in a client computer 32.

### Operations for Selection of and Sending of Streams

### A First Embodiment of Operation about Streams

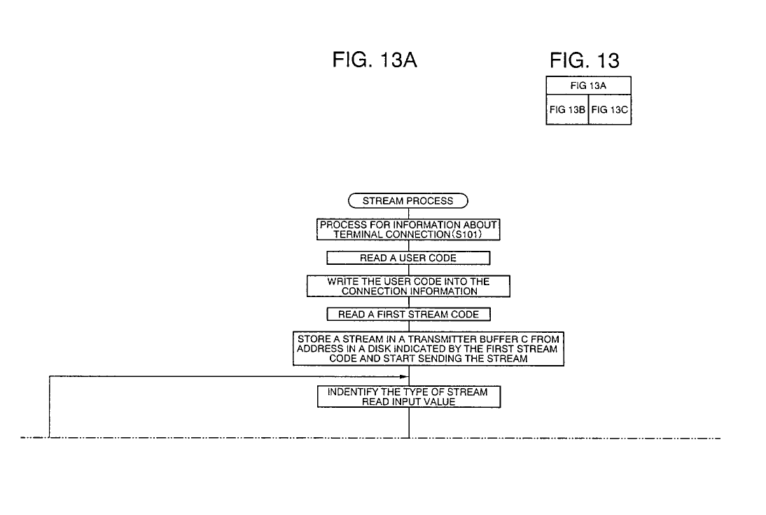

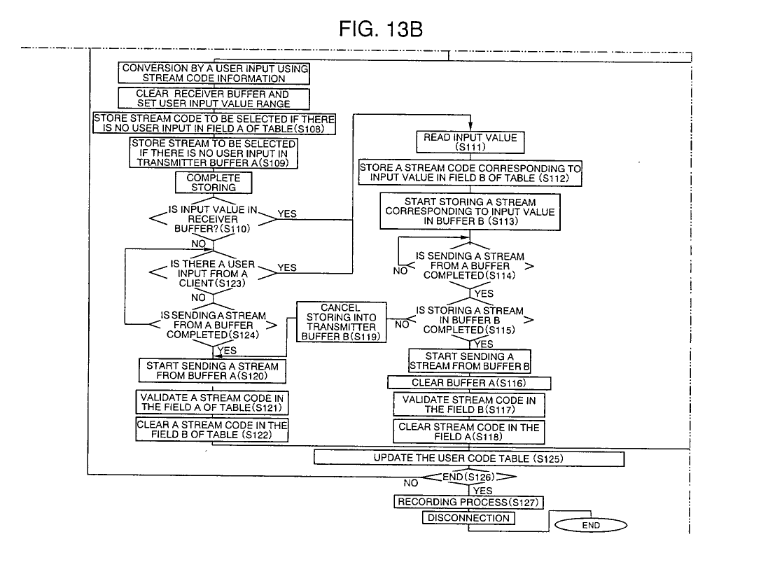

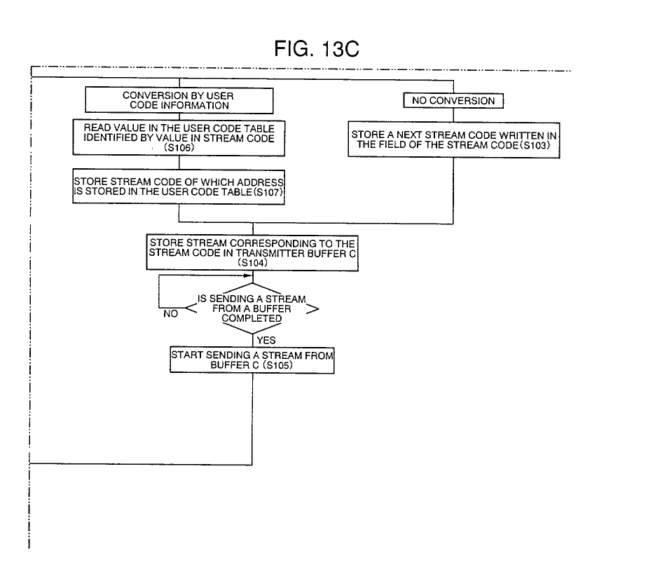

FIG. 13 is a flow diagram showing operations carried out in the server computer 31 for the selection and sending of streams. To begin with, information for connection with a client computer is processed (step S101). For example, a user code is read out and information about the connection is written into the user code table 90.

A first stream code is stored in the field 61-C of the table 60 from the random access memory 3. Then, a first stream corresponding to the first stream code is retrieved and fetched from the file 11 by using address information for a corresponding stream stored in the field 72 of the stream code. The first stream is transferred to and stored in the transmitter buffer 1-C from the file 11.

In the embodiment which is shown in FIG. 6 and FIG. 8, a stream code a corresponding to the stream a is a first stream code. The stream code a is stored in the field 61-C. Then, the first stream a is retrieved and fetched from the file 11 by using address information of the corresponding stream stored in the field 72 of the stream code a The first stream a is transferred to and stored in the transmitter buffer 1-C from the file 11. Then, the first stream a is sent to a client computer 32 from the transmitter buffer 1-C.

Predetermined criteria for selecting a next stream is identified by reading the contents in the stream code stored in the fields of the table 60 (step S102).

If the criteria for selecting a next stream is to always select a default stream for any condition, a next stream code is written into the field 62-C for an even transmission cycle of the table 60 in accordance with the address information stored in the field 73-C of the stream code 70 (step S103).

Then, a next stream is retrieved and fetched from the file 11 by using the address information of a corresponding stream which is stored in the field 72 of the stream code in the field 62-C. The next stream is transferred to and stored in the transmitter buffer 2-C for an even transmission cycle from the file 11.

Since the first stream code a always selects stream b as a next stream, stream code b is stored in the field 62-C of the table 60 from the random access memory 3 in accordance with the address information stored in the field 73-C of the stream code a. Then, the next stream b is retrieved and fetched from the file 11 by using the address information of a corresponding stream which is stored in the field 72 of the stream code b. The stream b is transferred to and stored in the transmitter buffer 2-C from the file 11.

Then, the server 31 examines whether or not sending a stream from the transmitter buffer 1-C is completed. If the sending a stream from the buffer 1-C is completed, then sending a next stream from the transmitter buffer 2-C for an even transmission cycle starts (step S105).

The sending a stream from the transmitter buffer 2-C starts immediately after the completion of sending of a preceding stream from the transmitter buffer 1-C if the distribution of streams is synchronous, that is, time taken to send a stream from the server 31 to a client 32 is the same as display time of a stream at the client 32. However, if the distribution of streams is asynchronous, that is, the display time of a stream at a client 32 is longer than the time taken to send a stream from the server 31 to the client 32, the sending a next stream starts after a timer provided in the server 31 counts out the overall display time of a preceding stream.

Information about the overall display time of a stream may be stored in a header portion of a stream. The counter provided in the server uses this information in order to count out the overall display time of a stream. It may be inaccurate to estimate the overall display time from a total byte size of a stream if the stream is compressed by a compression technique using variable bit rate. Alternatively, a stream code may contain the information about the overall display time of the corresponding stream.

If, in the step (S102), the criteria for selecting a next stream is to select a next stream by the conversion which uses information from the user code table 90, the server 31 reads a value q in the p-th field of the user code table 90 designated by a value p stored in the field 74p of the stream code 70 for designating a field in the user code table (S106) as shown in FIG. 9. Then, the server 31 uses the value q to read the address information of a next stream code stored in the q-th field of the conversion table 80 to store a next stream code in the field 62-C for an even transmission cycle of the table 60 (S107). The server 31 retrieves and fetches a next stream from the file 11 by using the address information of a corresponding stream stored in the field 72 of the stream code which is stored in the field 62-C and transfers the next stream to the transmitter buffer 2-C for an even transmission cycle from the file 11 (S104) in order to store the next stream there.

If, in the step (S102), the criteria for selecting a next stream is to select a next stream based on a user input, then the server 31 resets the receiver buffer 56 and sets a valid input value range. The valid input value range is stored in a stream code which corresponds to a stream which accepts a user input and is read by the server computer 31 each time when the stream accepting a user input is displayed. When a user input which is out of the valid input value range is received, such a user input is neglected by the server computer 31.

Then, the server computer 31 writes a next stream code into the field 62-A for even transmission cycle of the table 60 by using the address information for a next stream code corresponding to a next stream to be selected when there is no user input. The address information for the next stream code is stored in the field 73-A of stream code stored in the field 61-C of the table 60. The server 31 retrieves and fetches a next stream from the file 11 by using the address information of a corresponding stream stored in the field 72 of the stream code which is stored in the field 62-A and transfers the next stream to the transmitter buffer 2-A from the file 11 (S109) in order to store the next stream there. After the server 31 stores the next stream in the transmitter buffer 2-A, the server 31 examines whether or not a user input is received by reading the receiver buffer 56 (S110).

If a user input is received, then the server 31 reads the input value (S111) and reads the address for a next stream code stored in the field 73-B of the stream code in the field 61-C of the table 60. The server 31 reads a next stream by using the address in the field 73B for a next stream code to be selected in response to a user input and writes the stream code in the field 62-B of the table 60 (S112). The server retrieves and fetches a next stream from the file 11 by using the address information of a corresponding stream stored in the field 72 of the stream code which is stored in the field 62-B and transfers the next stream to the transmitter buffer 2-B for an even transmission cycle from the file 11 (S113) in order to store the next stream there.

Then, the server 31 examines whether or not sending a stream from the transmitter buffer 1-C is completed (S114). If the sending a stream from the buffer 1-C is completed, then the server 31 examines whether or not a next stream is completely stored into the transmitter buffer 2-B for even transmission cycle (S115). If the next stream is stored, then the server 31 starts sending the next stream from the transmitter buffer 2-B to the client 32, clears the transmitter buffer 2-A (step S105), validates a stream code in the field 62-B of the table 60 (S117), and clears a stream code in the field 62-A (S118).

If the storing next stream into the transmitter buffer 2-B is not completed at the step (S115), then the server 31 cancels the storing a next stream into the transmitter buffer 2-B (S119) and starts sending a next stream from the transmitter buffer 2-A (S120). The server 31 validates a stream code in the field 62-A of the table 60 (S121), and clears a stream code in the field 62-B (S122).

If, in step (S110), there is no user input value in the receiver buffer 56, then the server 31 examines whether or not there is a user input from a client 32 (S123). If there is a user input, then the operation goes to the step (S111).

If there is no user input, then the server 31 examines if sending a stream from the transmitter buffer 1-C is completed (S124). If the sending a stream is completed, the operation goes to step (S120). If the sending a stream is not completed, the operation returns to the step (S123).

As explained above, when a next stream is sent, the server 31 sends a next stream selected by a user input if a user input is received, or sends a default stream which is a stream to be sent when there is no user input, if there is no user input or if the user input can not be received by the server 31 in time for some reason. Therefore, this decreases the possibility that the sending streams is halted and the display of streams is interrupted due to communication errors or other cause.

As shown in FIG. 9, a value in a fields of the user code table 90 is updated by a value in particular field of stream code 70 (S125). It is examined if all of the stream processes are completed (S126). If not completed, the server examines valid stream codes in the fields 62-A, 62-B, and 62-C of the table 60 and the operation returns to the step (S102) to identify the criteria to select a next stream.

Since next selection and sending of a stream is an odd transmission cycle, the fields 61-A, 61-B, and 61-C of the table 60 and the transmitter buffers 1-A, 1-B, and 1-C for an odd transmission cycle are used.

In the embodiment shown in FIG. 6 and FIG. 8, the operation for selecting and sending streams is not completed at step (S126) since there is a valid stream code b stored in the field 62-C of the table 60. This stream code b is identified by step (S102) as a stream of which next stream is selected by a user input value. Then, the operation goes to step (S108).

If the operation for selecting and sending streams is completed (S126), then the operations stores information (S127) in the file 11, disconnects a client 32 from the server 31 and terminates the operations.

### A Second Embodiment of Operation about Streams

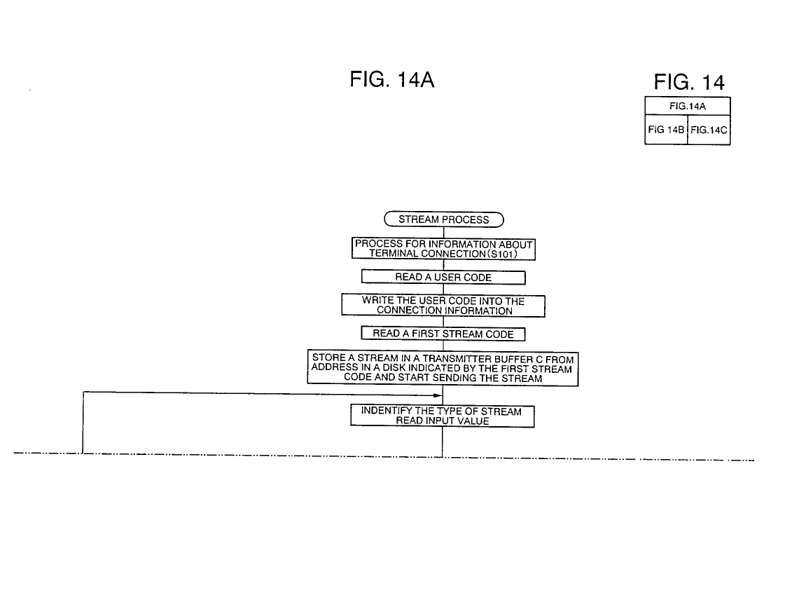

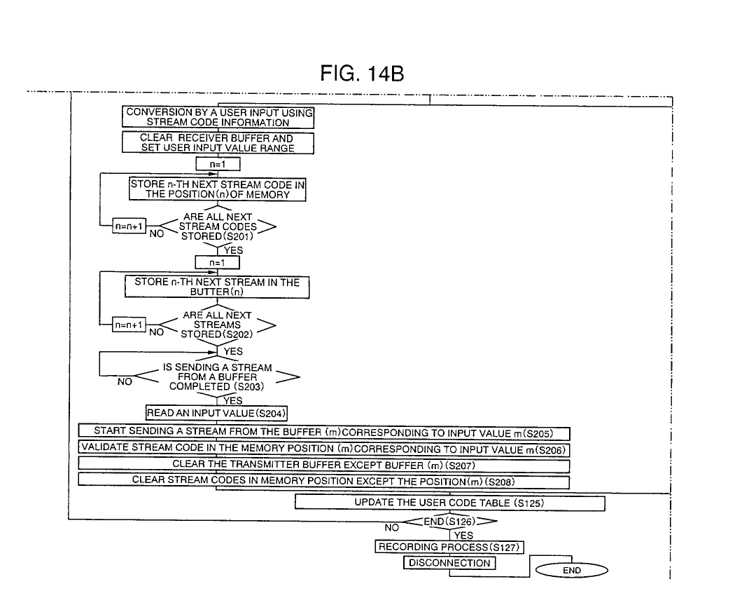

FIG. 14 is a flow diagram showing a second embodiment for processing streams. The steps in FIG. 14 of the second embodiment that are the same as the steps in FIG. 13 are not explained hereinafter.

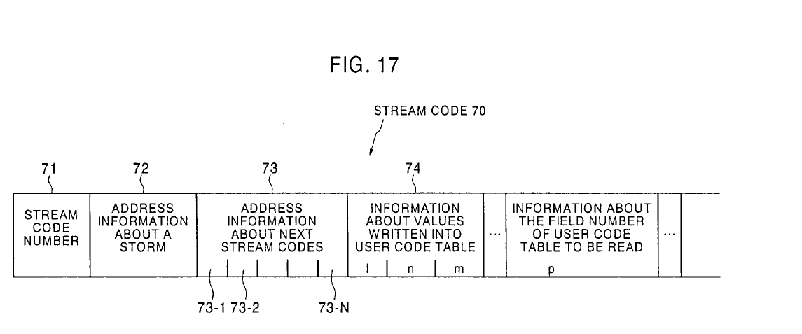

In the second embodiment in FIG. 14, a stream can accept several user inputs to select a next stream to be connected. Therefore, a next stream is selected by presence or absence of a user input and the kind of user inputs. There are three or more candidates, that is, n (n is the number three or more) next streams from which one stream is selected to be sent by the server 31 in response to a user input. As shown in FIG. 17, a stream code 70 corresponding to a stream accepting user inputs has sub-fields 73-1, 73-2, . . . , and 73-n for storing next stream codes corresponding to n next streams to be selected by user inputs.

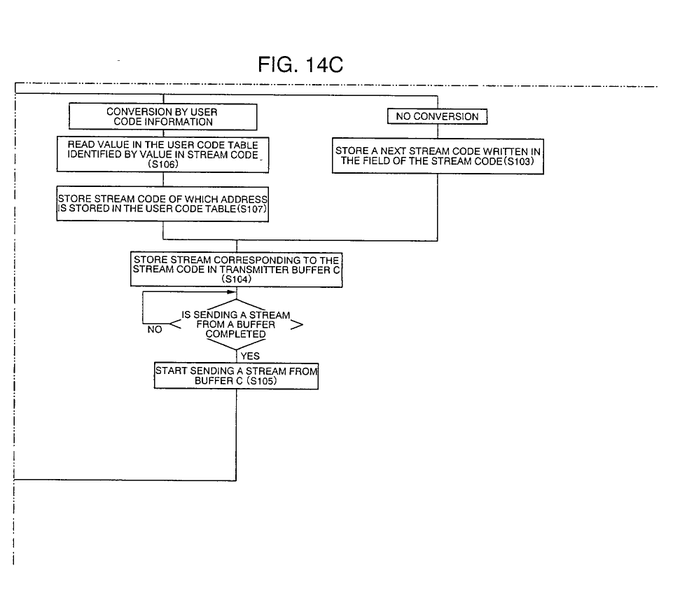

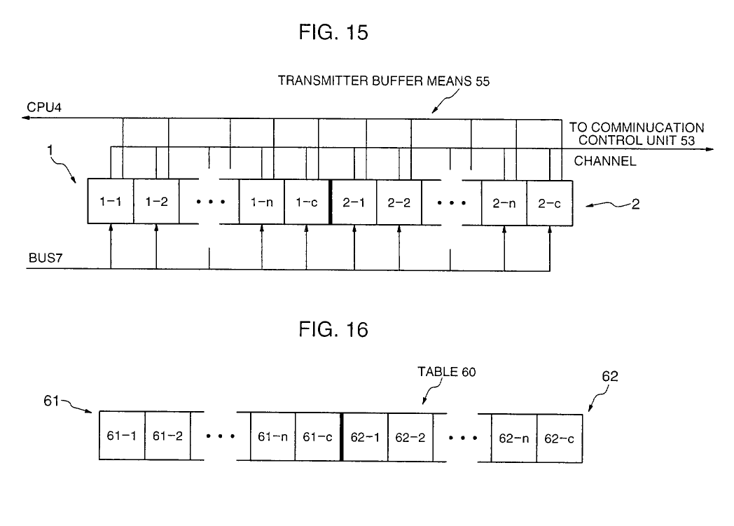

FIG. 15 is a schematic diagram of a transmitter buffer means 55 for use in the second embodiment of FIG. 14. A transmitter buffer means 55 is divided into a first buffer part 1 and a second buffer part 2. Each of buffer parts 1 and 2 is further divided into (n+1) sub-sections of buffers 1-1, 1-2, . . . , 1-n, and 1-C and 2-1, 2-2, . . . , 2-n, and 2-C, respectively.

FIG. 16 is a schematic diagram of a table 60 which is stored in a RAM 3 of the server 31 for storing stream codes for use in the second embodiment of FIG. 14. The table 60 has a first part 61 and a second part 22. Each of parts 61 and 62 is divided into (n+1) fields 61-1, 61-2, . . . , 61-n, and 61-C and 62-1,6 2-2, . . . , 62-n, and 62-C, respectively.

In step (S102), if a stream code indicates that a corresponding stream being displayed can accept two or more user inputs to select a next stream form three or more candidates of streams, a stream code corresponding to a first candidate of streams is read out from the RAM 3 by using address information stored in the field 73-1 of the stream code 70 as shown in FIG. 17.

The stream code which is read out from the RAM 3 by using address information stored in the field 73-1 of the stream code 70 of FIG. 17 is stored into the field 61-1 of the table 60 of FIG. 16 if the next transmission is an odd transmission cycle, or the field 61-2 of the table 60 of FIG. 16 if the next transmission is an even transmission cycle. This operation is repeated by using the fields 73-2, . . . , and 73-n of the stream code 70 of FIG. 17 until n next stream codes are read out from the RAM 3 and then stored into the fields 61-1, 61-2, . . . , and 61-n (when the next transmission is an odd transmission cycle) or the fields 62-1, 62-2, . . . , and 62-n (when the next transmission is an even transmission cycle) (S201).

Then, the server 31 retrieves and fetches next streams from the file 11 by using the address information stored in the field 72 of the stream code 70 of FIG. 17 stored in the table 60 and transfers the next streams from the file 11 to the transmitter buffer 1-1, 1-2, . . . , 1-n of FIG. 15 (when the next transmission is an odd transmission cycle) or the transmission buffer 2-1, 2-2, . . . , 2-n of FIG. 15 (when the next transmission is an even transmission cycle) (S202) in order to store the next stream there.

The nest step examines whether or not sending a stream from a transmitter buffer is completed (S203). If completed, then the receiver buffer 56 is examined whether not there is a received user input and its input value m (S204). In accordance with the input value m, the server 31 starts sending either of a next stream stored in a transmitter buffer 1-m (when the next transmission is an odd transmission cycle) or in a transmitter buffer 2-m (when the next transmission is an even transmission cycle) to a client 32 (S205).

In accordance with the input value m, either of the stream code stored in a field 61-m (when the transmission is an odd transmission cycle) or in a field 62-m (when the transmission is an even transmission cycle) of the table 60 of FIG. 16 is validated (S206).

All of the sub-sections of the transmitter buffer means 55 are reset except the buffer 1-m (when the transmission is an odd transmission cycle) or the buffer 2-m (when the transmission is an even transmission cycle) which is sending a stream to a client 32 (S207). All of the fields of the table 60 are reset except the field 61-m (when the transmission is an odd transmission cycle) or the field 62-m (when the transmission is an even transmission cycle) which stores the stream code corresponding to a stream being sent to a client 32 (S208).

### A Third Embodiment of Operations about Streams

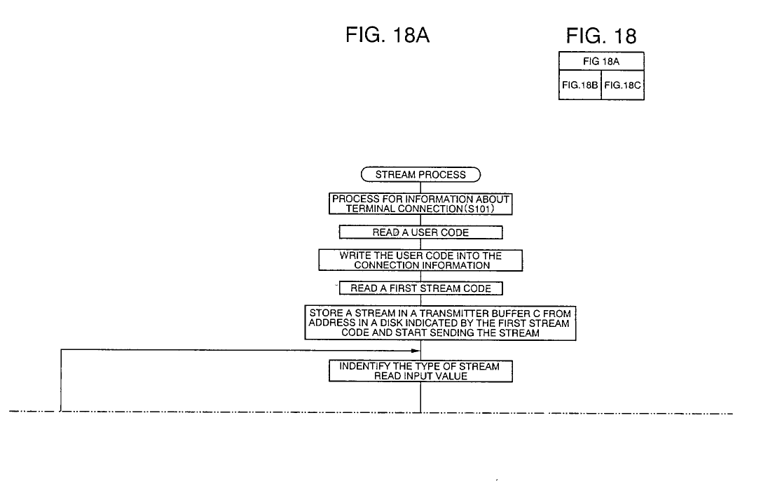

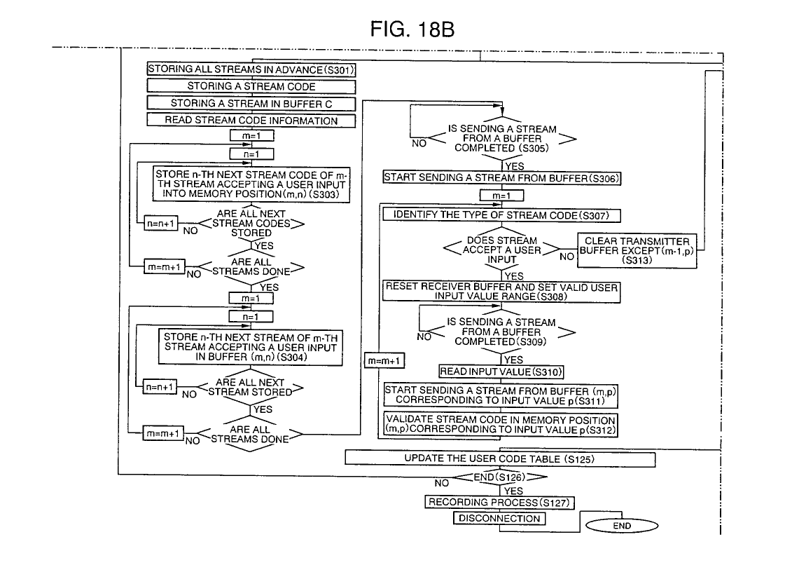

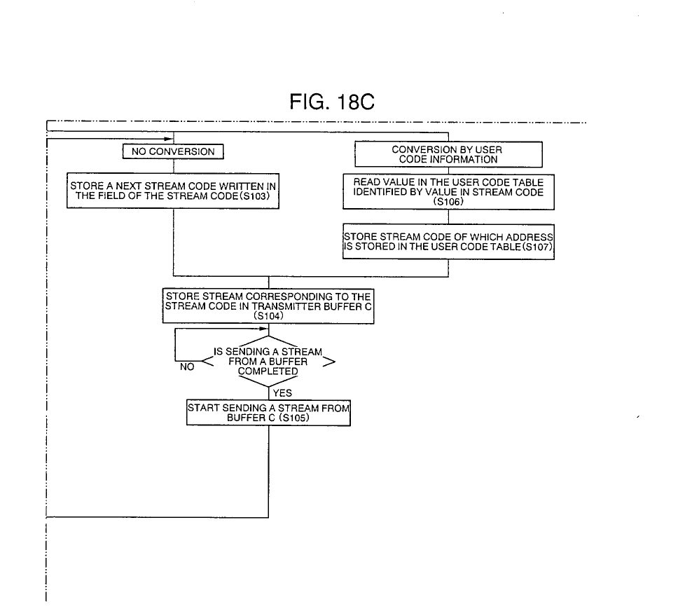

FIG. 18 is a flow diagram of a third embodiment for processing streams. The steps in FIG. 18 of the third embodiment which are the same as the steps in FIG. 13 are not explained hereinafter.

In the third embodiment shown in FIG. 18, all candidates of next streams to be selected for connection with a stream which accepts a user input are transferred to the transmitter buffer means 55 from the file 11 in order to store there in advance so as to select and send a next stream to a client 32 immediately.

For example, FIG. 18 shows a flow diagram of operations which transfer streams shown in FIG. 6 and FIG. 8 from the file 11 to the buffer means 55. In FIG. 18, the number of streams which can accept a user input is m. The number of candidates of next streams to be selected in response to a user input is n. It is assumed that m=3 and n=2 for the example of FIG. 6 and FIG. 8. It is easily understood by a person ordinarily skilled in the art that any number can be chosen for m and n.

At first, a type of streams is identified by examining a first stream code a as the type which requires the server 31 to transfer all candidates of next streams to be selected in response to a user input from the file 11 to the transmitter buffer means 55 in advance so that a next stream responding to a user input is selected and sent from the transmitter buffer means to a client 32 immediately after the server 31 reads the input value from the client 32 (S102). Then, the operation goes to an anticipatory transferring process (S301).

Stream code b of which address information is stored in the field 73C of stream code a is stored into the field 62-C of the table 60. Then, stream b is stored into the transmitter buffer 2-C from the file 11 by using stream address information in a corresponding stream field 72 of the stream code b.

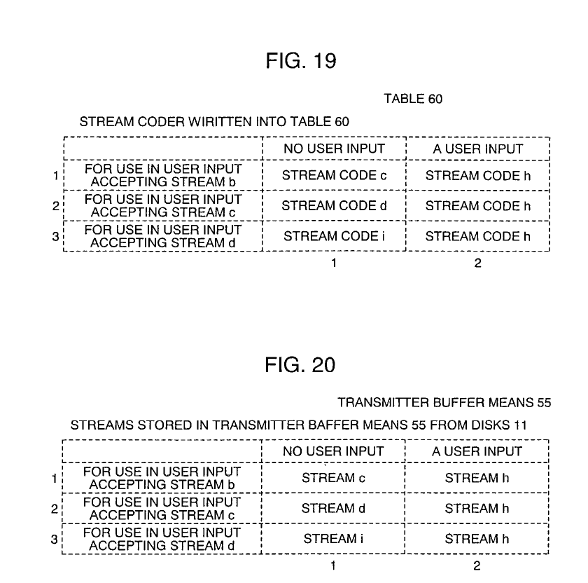

Stream codes c and h are stored into the fields (1,1) and (1,2) of the first line of the table 60, respectively, as shown in FIG. 19 by using address information for next stream codes stored in the fields 73 of stream code b as shown in FIG. 8. Then, stream codes d and h are stored into the fields (2,1) and (2,2) of the second line of the table 60, respectively, as shown in FIG. 19 by using address information for next stream codes stored in the fields 73 of stream code c as shown in FIG. 8. Then, stream codes i and h are stored into the fields (3,1) and (3,2) of the third line of the table 60, respectively, as shown in FIG. 19 by using address information for next stream codes stored in the fields 73 of stream code d as shown in FIG. 8 (S303).

Streams are stored into corresponding sub-sections of the transmitter buffer 55 of FIG. 20 from the file 11 by using stream address information stored in the field 72 of the stream codes in each field of the table 60 of FIG. 19. Streams c and h are stored into the sub-sections (1,1) and (1,2) of the first line of the transmitter buffer 55, respectively. Streams d and h are stored into the sub-sections (2,1) and (2,2) of the second line of the transmitter buffer 55, respectively. Streams i and h are stored into the sub-sections (3,1) and (3,2) of the third line of the transmitter buffer 55, respectively. These streams for use in the anticipatory transferring may be stored in areas of disks of the file 11 so that these streams can be transferred to the sub-sections of the transmitter buffer 55 with a single input/output operation.

After all candidates of next streams for m of streams which can accept a user input are stored into the sub-sections of the transmitter buffer means 55, the operation examines if the sending stream a from the transmitter buffer 1-C is completed (S305). If completed, next stream b is sent from the transmitter buffer 2-C (S306).

Stream code b in the field 62-C of the table 60 is examined if it accepts a user input (S307). Since stream code b accepts a user code, the receiver buffer 36 is reset and a valid user input value range p is set (S308). In this embodiment, p=1 when there is no user input or p=2 when there is a user input.

When sending stream b from the transmitter buffer 2-C is completed (S309), a user input value is read out (S310). If there is no user input, a user input value is p=1. Since stream b is the first stream which accepts a user input, m for stream b is 1. That is, m=1. Therefore, (m,p)=(1,1). The stream c stored in the sub-section (1,1) of the transmitter buffer means 55 which corresponds to (m,p)=(1,1) is sent to a client (S311).

Stream code c stored in the corresponding field (1,1) of the table 60 is validated (S312). Then, 1 is added to m=1 of the order of streams accepting a user input in order to make m=2 and the operation returns to the previous step (S307).

The operation examines stream code c whether stream code c accepts a user input (S307). Since stream code c accepts a user input, the operation resets the receiver buffer 56. When the sending stream c from the sub-section (1,1) of the transmitter buffer means is completed, a user input value is read (S310). If there is a user input, the input value is p=2. Since the value of m for the stream c is 2, m=2. Therefore, (m,p)=(2,2). Stream h stored in the sub-section (2,2) corresponding to (m,p)=(2,2) is sent to a client. Stream code h stored in the field (2,2) of the table 60 is validated. Then, 1 is added to m in order to make m=3.

The operation examines stream code h whether stream code h accepts a user input (S307). Since stream code h does not accept a user input, the operation clears the transmitter buffer 55 except for the sub-section (2,2) which stores stream h being sent (S319).

Since stream h has no next stream, the operation goes to an end step (S126) through step (S103). If stream h has a next stream, then the operation goes to step (S103) and steps following step (S103).

As explained above, the server computer of a preferred embodiment of the present invention comprises a transmission buffer means including a plurality of sub-sections to store a plurality of candidates of streams to be selected in advance. When sending of a stream from one of the sub-sections of the transmitter buffer means to a client is completed, a next stream is immediately selected from other sub-sections of the transmitter buffer means in order to send to the client immediately according to predetermined criteria, such as, presence or absence of a user input from the client.

### The Display Time of a Stream and Response Time to a User Input

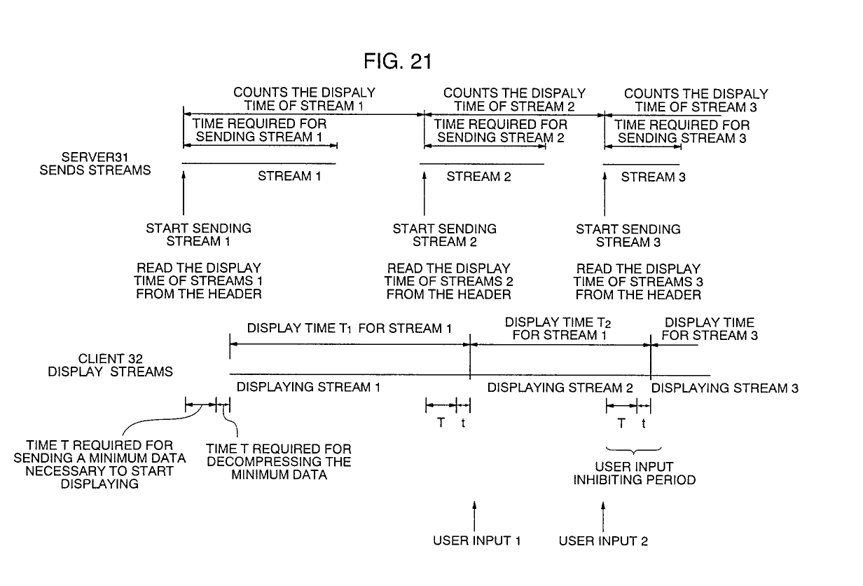

FIG. 21 is a timing chart showing relationship between the time required for sending a stream to a client terminal and the time required for displaying a stream on the client terminal. As explained above, if the display time of a stream on a client is longer than the time required to send a stream from a server to a client, a counter provided in the server computer counts the display time of a stream using display time information stored in a header of a stream. After the counter counts out the display time for a stream, the server 31 immediately selects a next stream based on a user input and sends the selected stream from a transmitter buffer to a client computer 32.

According to the present invention, the candidates of next streams are stored in the transmitter buffers in advance. Therefore, a next stream can be selected and sent from one of the buffers to a client immediately. The time required to send from the server 31 to a client 32 a minimum part of a stream necessary for the client 32 in order to start the display of the stream at the client 32 is defined as T. The time required to decompress that part at the client 32 is defined as t. The sum of (T+t) is usually very short.

As shown in FIG. 21, during the period of time (T+t), a user input from a client must be neglected or held for later process at the next stream. However, since the period of time (T+t) is very short as shown in FIG. 21, a user input can almost always be accepted during the display time of a stream.

The time required to respond to a user input also depends on the overall display time of a stream which accepts a user input. As shown in FIG. 21, if a user inputs an input 1 immediately after a stream 2 which accepts a user input starts, a next stream 3 responding to this user input 1 can not be displayed until the overall display time T2 of the stream 2 elapses. On the other hand, if a user inputs an input 2 just before the period of time (T+t) which inhibits a user input, a next stream 3 responding to this user input 2 can be displayed after the period of time (T+t) elapses. Therefore, the longest response time depends on the overall display time T2 of a stream. The shortest response time depends on the period of time (T+t).

A display time of a stream which accepts a use input is preferably selected between 0.5 seconds to 5 seconds so that a user feels as if an image being displayed responds to his/her input naturally.

If the display time of a stream is longer than 5 seconds, a user feels that an image responds to a user input with unnatural delay for almost all interactive audiovisual works. On the other hand, it is not necessary for any interactive audiovisual work to respond to a user input shorter than a stream having a display time of 0.5 seconds in order to respond to a user input naturally.

### Method of and Apparatus for Creating Streams

Streams are connected to display a continued motion pictures. The connection parts of both streams to be connected each other have the same or substantially the same image so that a continued motion pictures made from the both streams looks like seamless.

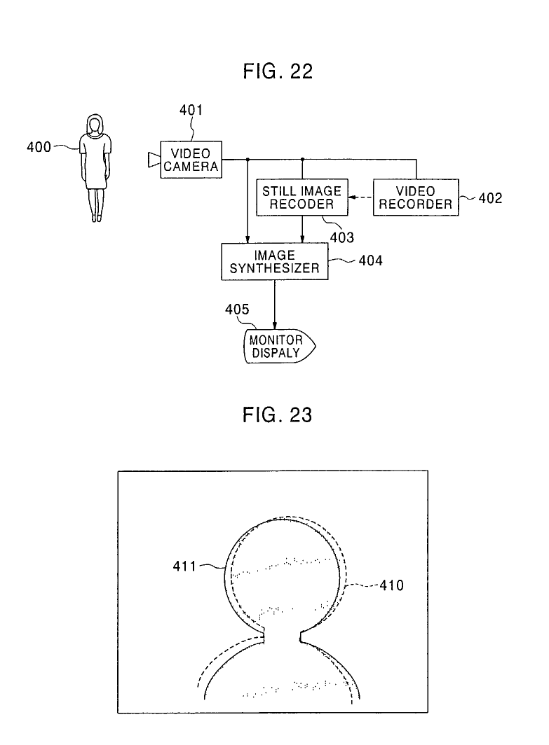

FIG. 22 is a schematic diagram of an apparatus for creating an interactive audiovisual work including a plurality of streams to be connected in accordance with a preferred embodiment of the present invention. The apparatus comprises a video camera 401 for taking motion pictures of an object 400, a recorder 402 for recording video data of motion pictures taken by the video camera, still image recording device 403 for making a still image from motion pictures taken by the video camera 401, an image synthesizer unit 404 for synthesizing image from the motion pictures from the video camera 401 and the still image from the still image recording device 403 by superimposing the motion pictures form the video camera 401 on the still image from the recording device 403 and reversing the right-hand side and the left-hand side of the superimposed image, and a monitor display 405 for displaying the synthesized and reversed image. The monitor display 405 may face the object 400.

Streams may be created by the apparatus as shown in FIG. 22 one by one in accordance with the flows or scenarios as shown in FIG. 4, FIG. 5, and FIG. 6. Alternatively, one long stream may be created by the apparatus as shown in FIG. 22. Then, the long stream may be divided into a plurality of short streams.

The connection parts of streams to be connected each other may be created by registering images of the connection parts when taking the motion pictures of each stream so as to have the same or substantially the same image. The connection parts of streams to be connected each other may be created by editing images of the connection parts by digital imaging technique after taking the motion pictures of each stream so as to have the same or substantially the same image. These two methods may be used together.

If an interactive audiovisual work is made from animation films, the connection parts of streams to be connected each other may be created by using animation technique or digital imaging technique so as to have the same or substantially the same image.

If the connection parts of streams to be connected is created by registering images of the connection parts when taking the motion pictures of each stream, the apparatus as shown in FIG. 22 may be used to record the connection part of each stream as still image in the still image recording device 403 when taking motion pictures of each stream. When taking a preceding stream with which a succeeding stream is connected, a still image of a connecting part, that is, an ending part, is stored into the still image recording device 403. When taking a succeeding stream with which a preceding stream is connected, a still image of a connecting part, that is, a staring part, is stored into the still image recording device 403.

The still image of a connection part, that is, an ending part or a starting part, of a stream recorded in the device 403 is used when taking motion pictures of a succeeding stream or preceding stream connecting that stream by the video camera401. The image synthesizer unit 404 synthesizes both the image of motion pictures from the video camera 401 and the still image from the recording device 403. The synthesizer unit 404 superimposes the image of motion pictures from the video camera on the still image from the recording device by adding image data of both images together with equal ratio 1:1 and reversing the right-hand side and left-hand side of both images. The ratio of both image data to be added may be altered so that an operator watching the monitor display 405 can recognize separately image from the video camera 401 and image from the still image recording device 403 by the brightness of each image. FIG. 23 shows a synthesized image according to a preferred embodiment of the present invention in which the image 410 from the video camera 401 is superimposed on the still image 411 from the still image recording device 403. Instead of superimposing, each of the image 410 from the video camera 401 and the image 411 from the recording device 403 may be alternatively displayed on the monitor display 405 at some intervals in order to make the registration of the images easy.

Alternatively, the outline is extracted from the still image 411 from the recording device 403. The image 410 from the video camera 401 is superimposed on the outline of the still image 411 to create a synthesized image. Then, the left-hand side and the right-hand side of the synthesized image is reversed. The reversed image is displayed on the monitor display 405. Alternatively, the outlines are extracted from the still image 411 from the recording device 403 and the image 410 from the video camera 401. The outline is superimposed each other to create a synthesized image. Then, the left-hand side and the right-hand side of the synthesized image is reversed. The reversed image is displayed on the monitor display 405. Alternatively, the discrepancy between the image 410 from the video camera 401 and the still image 411 from the recording device is detected. Then, the right-hand side and the left-hand side of the discrepancy is reversed. The reversed discrepancy is displayed on the monitor display 405. Alternatively, the discrepancy between both images is superimposed on the image 410 from the video camera 401 to create synthesized image. Then, the right-hand side and the left-hand side of the synthesized image is reversed. The reversed image is displayed on the monitor display 405. Alternatively, the image 410 from the video camera 401 or the still image 411 form the recording device 403 has different color from other image. Then, both of the image 410 from the video camera 410 and the image 411 from the recording device 403 are superimposed. The right-hand side and the left-hand side of the superimposed image is reversed. The reversed image is displayed on the monitor display 405. Alternatively, even number of scanning lines of one of the images 410 and 411 and odd number of scanning lines of the other of images 410 and 411 are combined to create a synthesized image. The right-hand side and the left-hand side of the synthesized image is reversed. The reversed image is displayed on the monitor screen 405.

As explained above, an operator can easily register the image 410 from the video camera 401 with the still image 411 from the still image recording device 403 by watching the synthesized image from the synthesizer unit 404 on the monitor display 405 and moving the object 400 so that the connection parts of streams to be connected have the same or substantially the same image.

Since the monitor display 405 displays a right-hand and left-hand reversed image, the movement of the object 400 in the synthesized image displayed on the monitor display 405 corresponds to the movement of the object 400. The operator can easily move the object 400 in order to register the both images on the monitor display 405. If the monitor display 405 switches the image 410 from the video camera 401 and the still image 411 at some intervals, the operator can easily understand how a stream is displayed from the connection part when that stream is connected during the creation of that stream.

If the connection parts of a preceding stream and/or a succeeding stream to be connected, particularly, the connection part of a succeeding stream have motion pictures created by moving the object 400 and/or the video camera 401, any small discrepancy of the images in the connecting parts between the preceding and succeeding streams are hardly recognized by a viewer since the viewer is occupied with the moving object and/or the viewer may think that discrepancy as a result of the moving object.

In order to take motion pictures for the connection part having such a movement, the amount and direction of the discrepancy of the images in the connecting parts between the preceding and the succeeding streams are determined. Then, the amount, direction and speed of the movement of the object or the part of object or the video camera which occurs when taking motion pictures of the connection part of a stream are determined. If any event which attracts attention of a viewer occurs in a succeeding stream after the discrepancy of the images, the viewer hardly notice the discrepancy since he or she is occupied with such an event.

In an interactive audiovisual work created by the method and apparatus according to a preferred embodiment of the present invention, the connection parts of streams to be connected have the same or substantially the same image. However, the connection parts of the streams may be further edited after taking motion pictures of the streams so that the streams seem to be connected seamlessly when the streams are displayed at a predetermined frame rate.

A first method of editing the connection parts of the streams is to select one frame from a plurality of frames in each of the connecting parts of a preceding stream and a succeeding stream which are most appropriate to connect both streams with these frames. The selected frame in a preceding stream becomes the last frame of the preceding stream. The selected frame in a succeeding stream becomes the first frame of the succeeding stream. Such a selection of appropriate frames for connection may be done between one stream and a plurality of streams to be connected to the one stream. Such a selection of appropriate frames for connection may be also done between a plurality of preceding streams and a plurality of succeeding streams.

The frames are selected from frames which have the most similarity in the images between the frames when the connection parts of the streams show a motion picture which is a still image or relatively still image. However, when the connection parts of the streams show motion pictures having a moving object or other motion, the frames may be selected from frames which have a discrepancy between the images of the frames which corresponds to the motion or the moving object.

A second method of editing the connection parts of the streams is to delete frames from the connecting parts or add copies of frames into the connection parts. The deleting frames from the connecting part makes an image of the connecting part move more quickly. The addition of the copies of the frames into the connecting part makes an image in the connecting part move more slowly. Deletion and addition of frames may be done either or both of connecting parts of a preceding stream and a succeeding stream. The speed of the image can be altered by using the deletion and/or addition of frames so that the discrepancy images between the connecting parts of streams to be connected looks like the natural movement of the image.

A third method of editing the connection parts of the streams is to create one or more interpolated frames having images created by digital imaging technique with a discrepancy in the images between the last frame of a preceding stream and the first frame of a succeeding frame. The interpolated frames are added to one of the connection parts of the streams to be connected in order to make the connection part seamless.

The above-mentioned editing streams may be done with all connection parts of streams. Then, the edited streams are compressed with a predetermined frame rate, indexed, and stored in the file.

According to the present invention, it is able to make the connection parts of streams virtually seamless with frame rate up to about 30 frames per second by using the above-mentioned techniques even if spatial frequencies at the connection parts of streams are high.

1. A system for distributing an interactive audiovisual work [in a server and client system], comprising:
an interactive audiovisual work including a plurality of streams of motion pictures which are selectively connected to display,
a server computer including storage means for storing the interactive audio visual work; means for receiving a signal from a client computer; means for selecting one of the plurality of the streams to be connected with a stream being displayed at the client computer in accordance with predetermined criteria; a plurality of buffer means for storing a plurality of the streams to be selected by the means for selecting in a predetermined order; and means for sending a stream selected by the means for selecting from the buffer means to the client computer, and
the client computer including means for receiving a user input; means for sending the user input to the server computer; means for receiving the streams from the server computer; and means for decompressing and displaying the received streams.

2. The system of claim 1, wherein said streams to be connected each other have the same or substantially the same image in connection parts thereof.

3. The system of claim 1, wherein at least one of said streams is a user input accepting stream which can accept a user input while being displayed at the client computer in order to select a next stream to be connected to display continued motion pictures.

4. The system of claim 3, wherein said user input accepting stream has a display time which is the sum of a predetermined period of time for accepting a user input and time required for selecting, sending and decompressing a next stream so as to respond to a user input immediately.

5. The system of claim 4, wherein said user input accepting stream has motion pictures of which display time is between 0.5 seconds and 5 seconds.

6. The system of claim 1, wherein said means for selecting includes stream codes, each of which corresponds to each of the streams, the stream codes including information about a next stream to be connected with the corresponding stream.

7. The system of claim 6, wherein said stream codes include information in order to select a next stream by said means for selecting depending on presence or absence of a user input or the kind of user inputs.

8. The system of claim 6, wherein said stream codes include information about a user and said means for selecting selects a next stream depending on the information about a user.

9. The system of claim 6, wherein the server computer has a random access memory in which said means for selecting creates a table having a plurality of fields when the server computer sends the interactive audiovisual work to the client computer and stores the stream codes in the fields in a predetermined order in order to use the stream code in the field to select a next stream.

10. The system of claim 9, wherein said plurality of buffer means include a first transmitter buffer and a second transmitter buffer in which said means for selecting alternately stores next streams in the fields of the table in accordance with the information of the stream code, said means for selecting selects a next stream alternately from the first transmitter buffer and the second transmitter buffer in accordance with the predetermined criteria, and said means for sending sends a stream selected by said means for selecting alternately from the first transmitter buffer and the second transmitter buffer to the client computer.

11. The system of claim 10, wherein each of said first and second transmitter buffers include a plurality of sub-sections, and next streams to be selected by said means for selecting in accordance with the same predetermined criteria are stored in corresponding sub-sections of said first and second transmitter buffers.

12. The system of claim 11, wherein said sub-sections include a first sub-section, a second sub-section and a third sub-section, and said means for selecting stores a next stream to be selected when there is no user input in the first subsection, a next stream to be selected when there is a user input in the second subsection and a next stream to be selected in accordance with other than a user input in the third sub-section.

13. The system of claim 12, wherein a next stream to be selected in accordance with information about a user is stored in said third sub-section.

14. The system of claim 12, wherein a next stream to be always selected by said means for selecting is stored in said third sub-section.

15. The system of claim 12, wherein said means for selecting at first stores a next stream in the first sub-section and then stores a next stream in the second sub-section; when said means for sending starts sending a stream before the means for selecting completes storing a next stream in the second sub-section, the means for selecting cancel the storing a next stream in the second sub-section, and said means for sending sends a next stream stored in the first sub-section irrespective of presence and absence of a user input.

16. The system of claim 9, wherein said means for selecting stores stream code corresponding to a user input accepting stream and a next stream code designated by said stream code corresponding to a user input accepting stream in the fields of the table in a predetermined order, and stores the stream corresponding said stream code and said next stream code in the transmitter buffer in a predetermined order, when the server computer distributes the interactive audiovisual work to the client computer.

17. A method of distributing an interactive audiovisual work from a server computer to a client computer in response to a user input [in a server and client system], comprising steps of:
providing means for storing in the server computer;
storing in the means for storing an interactive audiovisual work including a plurality of streams of motion pictures which are selectively connected to display;
storing in the means for storing stream codes, each of which corresponds to each of the streams and includes information about a next stream able to be connected;
providing a random access memory in the server computer;
storing the stream codes in the random access memory when the server computer sends the streams to the client computer;
creating a table having a plurality of fields in the random access memory;
storing the stream codes in the fields of the table in a predetermined order;
providing a plurality of transmitter buffers in the server computer;
storing in the transmitter buffers the streams corresponding to the stream codes stored in the fields of the table; and
in accordance with predetermined criteria, selecting the streams stored in the transmitter buffers to send to the client computer.

18. The method of claim 17, wherein said predetermined criteria is one of selecting a default next stream always, selecting a next stream depending on information about a user, and selecting a next stream depending on presence or absence of a user input.

19. The method of claim 17, wherein said predetermined order is to store the stream codes in the fields depending on information about a next stream included in the stream code.

20. An apparatus for creating image data, comprising:
means for taking motion pictures of an object and generating video data of the motion pictures,
still image recording means for recording a still image data made from the video data;
image synthesizing means for generating a synthesized image from the video data from the means for taking motion pictures and the still image data from the still image recording means by superimposing the video data on the still image data; and
means for displaying one of image of the video data from the means for taking motion pictures, image of the still image data from the still image recording means; and the synthesized image with its right-hand side and left-hand side being reversed.

21. A method of creating a preceding stream and a succeeding stream of motion pictures which are connected to display, comprising the steps of:
taking motion pictures of a preceding stream by video camera means;
displaying a still image of ending part of the preceding stream which connects a succeeding stream;
displaying an image of starting part of the succeeding stream which connects the preceding stream when starting taking motion pictures of the succeeding stream by the video camera means;
substantially registering the image of starting part of the succeeding stream with the still image of ending part of the preceding stream by alternately repeating the steps of displaying a still image and of displaying an image of starting part; and
taking motion pictures of the succeeding stream from the starting part having substantially registered with the still image.

22. A system for distributing an interactive audiovisual work, comprising:
an interactive audiovisual work including a plurality of streams of motion pictures; the streams being selectively connected to display,
a server computer including storage means for storing the interactive audio visual work; means for receiving a signal from a client computer; means for selecting one of the plurality of the streams to be connected with a stream being displayed on the client computer in accordance with predetermined criteria; a plurality of buffer means for storing a plurality of the streams to be selected by the means for selecting in a predetermined order; and means for sending a stream selected by the means for selecting from the buffer means to the client computer, and
a client computer including means for receiving a user input; means for sending the user input to the server computer; means for receiving the stream from the server computer; and means for decompressing and displaying the received stream;
wherein the streams to be selectively connected each other have connecting parts which are substantially special or sequential continuous.

23. A system for distributing an interactive audiovisual work, comprising:
an interactive audiovisual work including a plurality of streams of motion pictures which are selectively connected to display,
a server computer including storage means for storing the interactive audio visual work; means for receiving a signal from a client computer; means for selecting one of the plurality of the streams to be connected with a stream being displayed at the client computer in accordance with predetermined criteria; a user code table for changing the predetermined criteria user by user; a plurality of buffer means for storing a plurality of the streams to be selected by the means for selecting in a predetermined order; and means for sending a stream selected by the means for selecting from the buffer means to the client computer, and
a client computer including means for receiving a user input; means for sending the user input to the server computer; means for receiving the stream from the server computer; and means for decompressing and displaying the received stream.

24. A system for distributing an interactive audiovisual work, comprising:
an interactive audiovisual work including a plurality of streams of motion pictures which are selectively connected to display,
a server computer including storage means for storing the interactive audio visual work; means for receiving a signal from a client computer; means for selecting one of the plurality of the streams to be connected with a stream being displayed at the client computer in accordance with predetermined criteria; a plurality of buffer means for storing a plurality of the streams to be selected by the means for selecting in a predetermined order; and means for sending a stream selected by the means for selecting from the buffer means to the client computer by canceling the sending of a stream then being sent, and
a client computer including means for receiving a user input; means for sending the user input to the server computer; means for receiving the stream from the server computer; and means for decompressing and displaying the received stream.

25. A system for distributing an interactive audiovisual work, comprising:
an interactive audiovisual work including a plurality of streams of motion pictures which are selectively connected to display,
a server computer including storage means for storing the interactive audio visual work; means for receiving a signal from a client computer; means for selecting one of the plurality of the streams to be connected with a stream being displayed at the client computer in accordance with predetermined criteria including stream codes corresponding to each of the streams; the stream code including information about a next stream to be connected with the corresponding stream; the information about a next stream including user information which is changeable in order to select a next stream for a user depending on the user's history about the use of the interactive audiovisual work; a plurality of buffer means for storing a plurality of the streams to be selected by the means for selecting in a predetermined order; and means for sending a stream selected by the means for selecting from the buffer means to the client computer, and
a client computer including means for receiving a user input; means for sending the user input to the server computer; means for receiving the stream from the server computer; and means for decompressing and displaying the received stream.
